(19) United States
(12) Patent Application Publication
(10) Pub. No.: US 2003/0059051 A1
(43) Pub. Date: Mar. 27, 2003

(54) Electronic apparatus, wireless communication device, and encryption key setting method

(75) Inventors: Ken Hatano, Ome-shi (JP); Koichi Kaji, Hidaka-shi (JP)

Correspondence Address: Finnegan, Henderson, Farabow,, Garrett & Dunner, L.L.P., 1300 I Street, N.W., Washington, DC, 20005-3315, US

(73) Assignee: KABUSHIKI KAISHA TOSHIBA

(21) Appl. No.: 10/233,499

(22) Filed: Sep. 4, 2002

(30) Foreign Application Priority Data
Sep. 27, 2001 (JP) 2001-298631

(51) Int. Cl. H04L 9/00

(52) U.S. Cl. 380/270

(57) ABSTRACT

A wireless device is a product to be shipped by a manufacturer/distribution source, which is an object to be processed by an electronic apparatus of this invention. A unique information acquisition unit of a personal computer acquires information unique to the wireless device (e.g., a production number, MAC address, or the like) using a barcode reader. An encryption key generation unit uses the information acquired by the unique information acquisition unit to generate an encryption key used when the wireless device makes wireless communications. An encryption key setting instruction unit issues a command for setting the encryption key generated by the encryption key generation unit to the wireless device. On the other hand, in the wireless device that receives this command, an encryption key setting unit sets this encryption key.

### CROSS-REFERENCE TO RELATED APPLICATIONS

This application is based upon and claims the benefit of priority from the prior Japanese Patent Application No. 2001-298631, filed Sep. 27, 2001, the entire contents of which are incorporated herein by reference.

### BACKGROUND OF THE INVENTION

1. Field of the Invention

The present invention relates to an electronic apparatus for setting an encryption key in a wireless communication device such as a wireless LAN access point or the like, a wireless communication device having a function of setting an encryption key of the device, and an encryption key setting method and, more particularly, to an electronic apparatus, a wireless communication device, and an encryption key setting method which can maintain security even when an encryption key is used in a default state.

2. Description of the Related Art

In recent years, wireless communication systems for personal areas such as a wireless LAN (IEEE802.11b), Bluetooth, and the like have received a lot of attention. Such wireless communication system has a function of making connection authentication using an encryption key to maintain security, since a radio wave may be intercepted due to its characteristics, and anyone may establish connection to a network environment.

Hence, the user makes operations for, e.g., synchronously setting an identical encryption key among a plurality of wireless communication devices, which are to undergo wireless communications.

For example, as security in IEEE802.11, a method that uses a 40-bit encrypted code called a WEP (Wired Equivalent Privacy) key and denies connection from a wireless device other than those having an identical WEP code, a method that makes a group setup among wireless devices called SS-ID (Service Set ID), and the like are known.

However, not all users are really aware of the need for security maintenance, and may begin to use wireless communication devices regardless of an encryption key.

On the other hand, since the manufacturers and distribution sources of wireless communication devices assume user's setups of an encryption key, they ship devices without setting any encryption key or by tentatively setting a predetermined encryption key. Therefore, when the user uses a wireless communication device in a default state upon shipping, communications may be made with unintended partners. That is, if an access point used to build a wireless LAN is used in such state, access from illicit users may be permitted.

### BRIEF SUMMARY OF THE INVENTION

The present invention has been made in consideration of the above situation, and has as its object to provide an electronic apparatus, a wireless communication device, and an encryption key setting method which can maintain security even when an encryption key is used in a default state.

In order to achieve the above object, the present invention provides an electronic apparatus comprising a first unit configured to acquire a device unique information of a wireless communication device, a second unit configured to generate a data encryption key used when the wireless communication device makes a wireless communication based on the device unique information acquired by the first unit, and a third unit configured to set the encryption key generated by the second unit in the wireless communication device.

This electronic apparatus acquires information unique to a wireless communication device such as a production number, MAC (Media Access Control) address, or the like upon, e.g., shipping from the manufacturer or distribution source, generates an encryption key based on that unique information, and sets the key in each wireless communication device.

That is, since this electronic apparatus automates very troublesome, impractical operations for assigning unique encryption keys to products one by one if they are made as usual, even when the user begins to use a wireless communication device in a default state upon shipping, communications with unintended partners can be avoided, and high security can be maintained.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently embodiments of the invention, and together with the general description given above and the detailed description of the embodiments given below, serve to explain the principles of the invention.

FIG. 1 is an overall diagram of an electronic apparatus according to the first embodiment of the present invention;

FIG. 2 is a block diagram showing the hardware arrangement of a personal computer in the first embodiment;

FIG. 3 is a block diagram showing the hardware arrangement of a wireless device in the first embodiment;

FIG. 4 is a flow chart showing the operation sequence of the electronic apparatus of the first embodiment;

FIG. 5 is an overall diagram of an electronic apparatus according to the second embodiment of the present invention;

FIG. 6 is a flow chart showing the operation sequence of the electronic apparatus of the second embodiment;

FIG. 7 is an overall diagram of an electronic apparatus according to the third embodiment of the present invention; and

FIG. 8 is a flow chart showing the operation sequence of the electronic apparatus of the third embodiment.

### DETAILED DESCRIPTION OF THE INVENTION

Embodiments of the present invention will be described hereinafter with reference to the accompanying drawings.

(First Embodiment)

The first embodiment of the present invention will be described below.

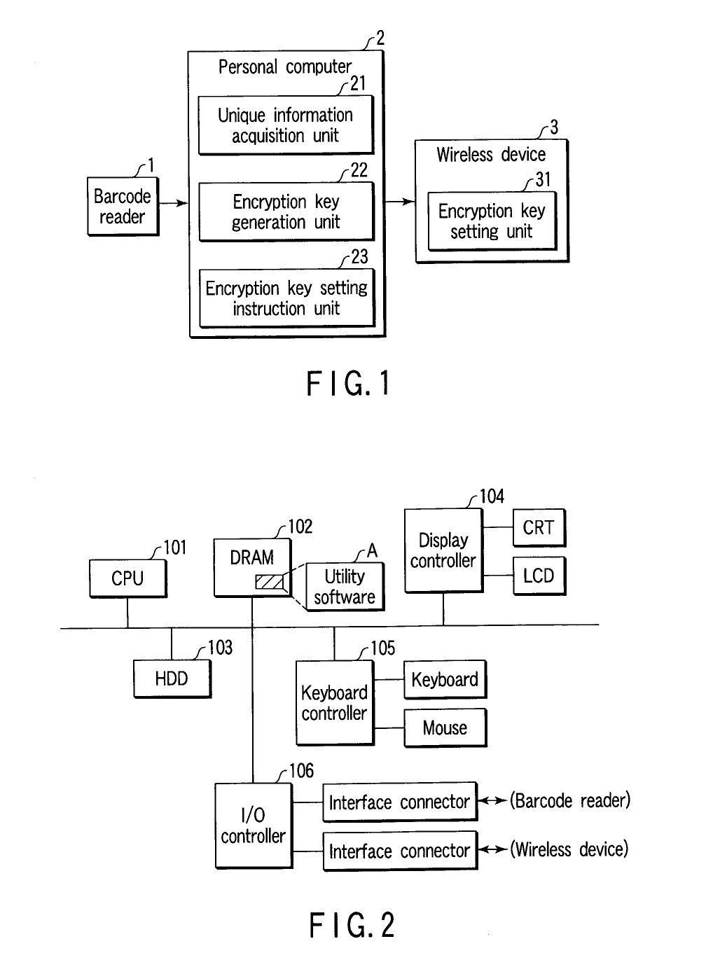

FIG. 1 is an overall diagram of an electronic apparatus according to the first embodiment. As shown in FIG. 1, in this electronic apparatus, a barcode reader 1 and personal computer 2 are connected, and the personal computer 2 and wireless device 3 are connected. The wireless device 3 is, for example, a wireless LAN access point, and is a product, which is to be processed by the electronic apparatus, and has been shipped from a manufacturer or distribution source.

The personal computer 2 comprises a unique information acquisition unit 21, encryption key generation unit 22, and encryption key setting instruction unit 23, and the wireless device 3 comprises an encryption key setting unit 31.

FIG. 2 shows the hardware arrangement of the personal computer 2. This personal computer 2 is a desktop or notebook type computer, and has a CPU 101, DRAM 102, HDD 103, display controller 104, keyboard controller 105, and I/O controller 106, as shown in FIG. 2.

The CPU 101 systematically controls the operation of this personal computer 2, and controls the operations of respective units in accordance with descriptions of various programs which are stored in the DRAM 102 and include utility software A. The utility software A is a program that makes this personal computer 2 operate as an electronic apparatus, is loaded from the HDD 103, and is stored in the DRAM 102 as needed. The unique information acquisition unit 21, encryption key generation unit 22, and encryption key setting instruction unit 23 shown in FIG. 1 are implemented by this utility software A.

The DRAM 102 is a memory device, which serves as a main memory of this personal computer 2, and stores various programs including the utility software A, and various data to be input/output to/from these programs. The HDD 103 is a memory device, which serves as an external memory of this personal computer 2, and stores various programs and various data in large quantities as a secondary memory of the DRAM 102.

The display controller 104 controls output of a user interface of this personal computer 2, and displays display data generated by the CPU 101 on a CRT or LCD. On the other hand, the keyboard controller 105 controls input of the user interface of this personal computer 2, converts operations of a keyboard and mouse into digital data, and passes them to the CPU 101.

The I/O controller 106 controls wired communications with external devices, and the personal computer 2 is connected to the barcode reader 1 and wireless device 3 via interface connectors equipped by this I/O controller 106.

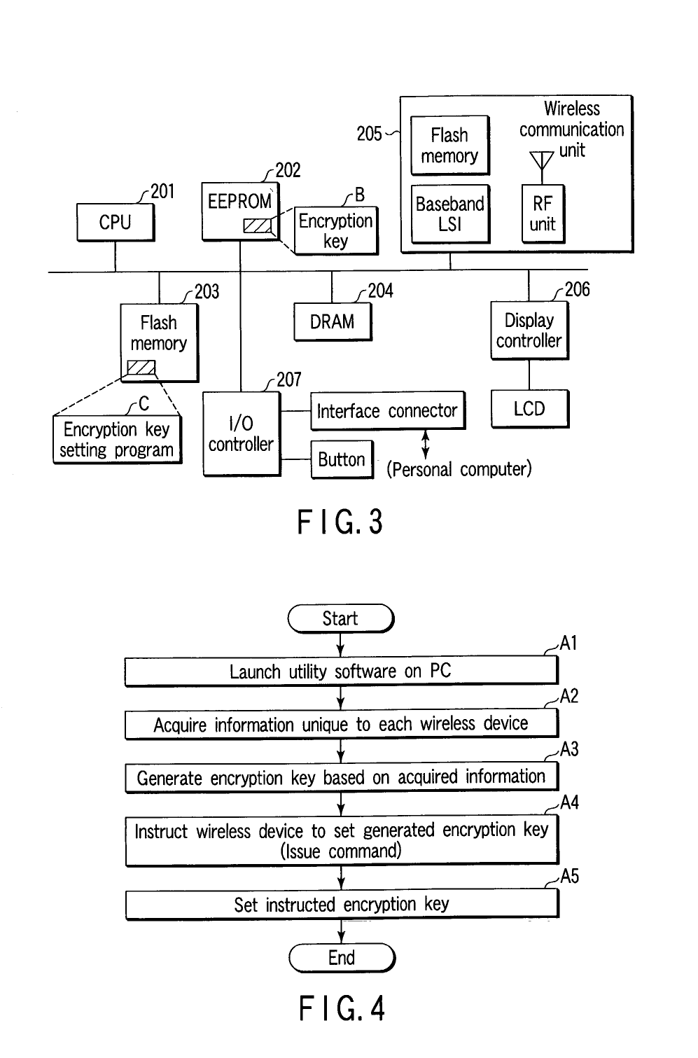

FIG. 3 shows the hardware arrangement of the wireless device 3. This wireless device 3 makes wireless communications complying with the wireless LAN (IEEE802.11b) standard, and has a CPU 201, EEPROM 202, flash memory 203, DRAM 204, wireless communication unit 205, display controller 206, and I/O controller 207, as shown in FIG. 3.

The IEEE802.11b system makes wireless communications using a 2.4-GHz band called an ISM (Industrial Scientific Medical) band, and uses DSSS (Direct Sequence Spread Spectrum) as a modulation method of signals to be exchanged. Furthermore, the 2.4-GHz band (2.4000 to 2.4835 GHz) is used while being divided into 14 channels (channels that can be used are limited depending on countries). The frequency band per channel corresponds to a range of ±11 MHz from the central frequency of each channel, i.e., 22 MHz. This communication channel is set to use an identical channel among devices which make wireless communications.

The CPU 201 systematically controls the operation of this wireless device 3, and controls the operations of respective units in accordance with descriptions of various programs, which are stored in the flash memory 203 and include encryption key setting program C. The encryption key setting program C is used to set an encryption key B, which is stored in the EEPROM 202 and is used in connection authentication upon making wireless communications. The electronic apparatus uses, as the encryption key B, for example, a WEP (Wired Equivalent Privacy) key or ESS-ID (Extended Service Set-ID) specified by IEEE802.11b. The encryption key setting unit 31 shown in FIG. 1 is implemented by the encryption key setting program C.

The EEPROM 202 is a memory device that stores various kinds of setting information including the encryption key B, and the flash memory 203 is a memory device that stores various programs including the encryption key setting program C. The DRAM 204 is a memory device that serves as a work area of the CPU 201.

The wireless communication unit 205 controls wireless communication with another wireless device, and comprises a baseband LSI for controlling the IEEE802.11b wireless function, a flash memory for storing a program to be executed by this baseband LSI, an antenna, and an RF unit for controlling RF signals between the baseband LSI and antenna.

The display controller 205 controls output of a user interface of the wireless device 3, and displays display data generated by the CPU 201 on an LCD. On the other hand, the I/O controller 207 controls input of the user interface of the wireless device 3, and informs the CPU 201 of depressions of various buttons. The I/O controller 207 also controls wired communications with an external device, and the wireless device 3 is connected to the personal computer 2 via an interface connector equipped in this I/O controller 207.

The operation of the electronic apparatus with such hardware arrangement will be explained below. FIG. 4 is a flow chart showing the operation sequence of this electronic apparatus.

When the manufacturer/distribution source of the wireless device 3 sets the encryption key B of the wireless device 3 upon shipping, an operator launches the utility software A on the personal computer 2 (step A1).

After the utility software A is launched, since the unique information acquisition unit 21, encryption key generation unit 22, and encryption key setting instruction unit 23 begin to run, the operator reads the production number, MAC address, or the like, which is printed as a barcode on an order form using the barcode reader 1. The production number, MAC address, or the like, which is read by the barcode reader 1, is acquired by the unique information acquisition unit 21 as information unique to the wireless device 3 (step A2).

The unique information acquisition unit 21 transfers the acquired information to the encryption key generation unit 22. On the other hand, the encryption key generation unit 22 generates an encryption key used by the wireless device 3 in wireless communications, on the basis of the transferred information (step A3). The encryption key generation method in this encryption key generation unit 22 is not particularly limited as long as the method can be given certain regularity, i.e., is reconstructible (e.g., a key may be generated by scrambling some or all digits of the production number or MAC address in a predetermined procedure). Also, some or all digits of the production number or MAC address may be directly used as an encryption key by only adjusting the number of digits.

The encryption key setting instruction unit 23 issues a command for setting the encryption key generated by the encryption key generation unit 22 to the wireless device 3 via the I/O controller 106 (step A4). In the wireless device 3 that receives this command via the I/O controller 207, the encryption key setting unit 31 stores this encryption key in the EEPROM 202 (step A5).

The operator then repeats the aforementioned processes while exchanging the wireless device 3 to be connected to the personal computer 2.

As described above, the electronic apparatus of this embodiment can easily set an encryption key unique to each wireless device 3. Even when the user begins to use a wireless communication device in the same default state as that upon shipping, communications with unintended partners can be prevented, and security can be maintained.

(Second Embodiment)

The second embodiment of the present invention will be described below.

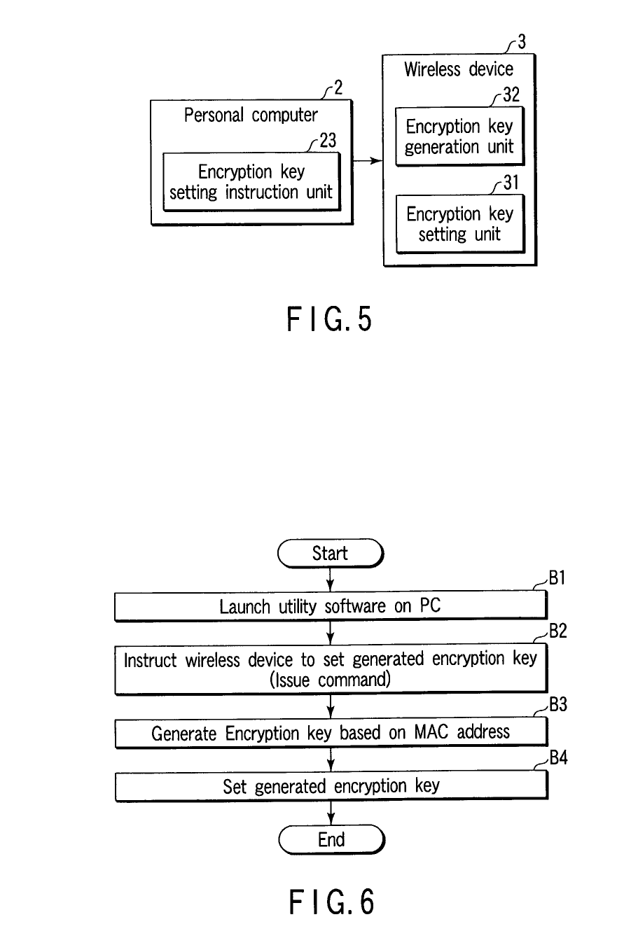

FIG. 5 is an overall diagram of an electronic apparatus according to the second embodiment. The difference between the electronic apparatuses of the first and second embodiments lies in that the wireless device 3 itself comprises an encryption key generation unit 32, as shown in FIG. 5. When the personal computer 2 issues a command for setting an encryption key, the encryption key generation unit 32 reads out, e.g., a MAC address assigned to the device from the EEPROM 202, and generates an encryption key that the device uses in wireless communications, using the readout MAC address.

As a result, in the personal computer 2, the need for connection with the barcode reader 1, and the unique information acquisition unit 21 and encryption key generation unit 22 can be obviated, and the encryption key setting instruction unit 23 need only have a function of issuing a command for setting an encryption key (without transferring the encryption key itself).

FIG. 6 is a flow chart showing the operation sequence of the electronic apparatus of the second embodiment.

An operator in the manufacturer/distribution source of the wireless device 3 launches the utility software A on the personal computer 2 (step B1). After the utility software A is launched, since the encryption key setting instruction unit 23 begins to run, the operator makes this encryption key setting instruction unit 23 issue a command for setting an encryption key to the wireless device 3 via the I/O controller 106 (step B2).

On the other hand, in the wireless device 3 that receives this command via the I/O controller 207, the encryption key generation unit 32 generates an encryption key to be used in wireless communications, on the basis of a MAC address assigned to the device (step B3). The encryption key setting unit 31 then stores the encryption key generated by the encryption key generation unit 32 in the EEPROM 202 (step B4).

The operator then repeats the aforementioned processes while exchanging the wireless device 3 to be connected to the personal computer 2.

As described above, the electronic apparatus of this embodiment can easily set an encryption key unique to each wireless device 3 as well. Even when the user begins to use a wireless communication device in the same default state as that upon shipping, communications with unintended partners can be prevented, and security can be maintained.

In this embodiment, the encryption key generation unit 32 and encryption key setting unit 31 run in response to the command from the personal computer 2. Alternatively, a button for instructing to set an encryption key may be provided to the wireless device 3, and the encryption key generation unit 32 and encryption key setting unit 31 may run when the I/O controller 207 of the wireless device 3 detects operation of this button. In this case, the wireless device 3 can set an encryption key by itself, and the operator need only operate the predetermined button provided to the wireless device 3.

(Third Embodiment)

The third embodiment of the present invention will be described below.

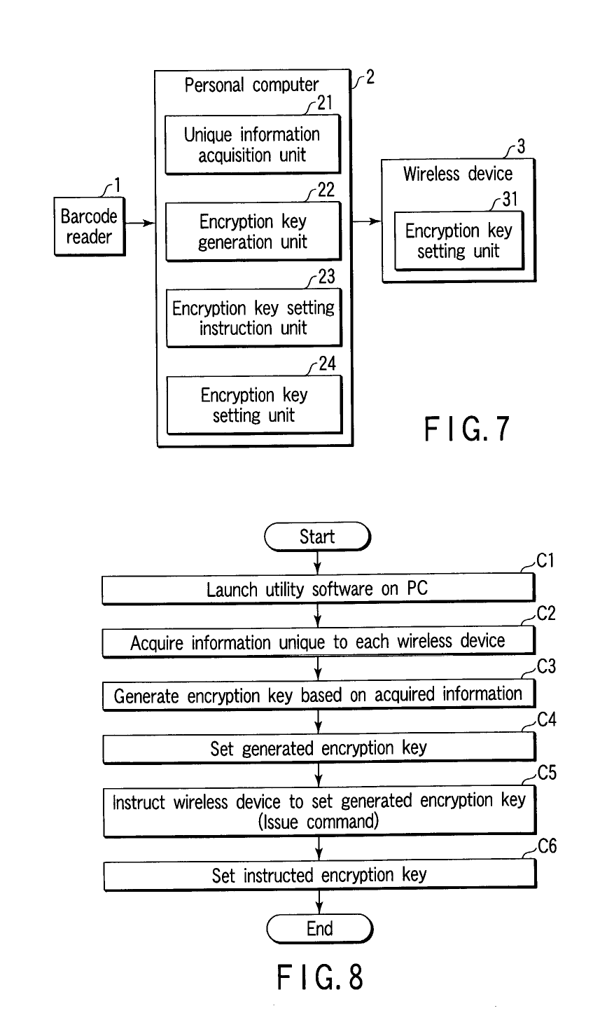

FIG. 7 is an overall diagram of an electronic apparatus according to the third embodiment. The difference between the electronic apparatuses of the first and third embodiments lies in that the personal computer 2 also has an encryption key setting unit 24, as shown in FIG. 7. When the encryption key setting instruction unit 23 issues a command for setting an encryption key to the wireless device 3, the encryption key setting unit 24 also sets that encryption key in the personal computer 2.

This electronic apparatus of the third embodiment assumes that the personal computer 2 is also an object to be processed, i.e., it is a product to be shipped from the manufacturer/distribution source, and a set of the personal computer 2 and wireless device 3 are shipped to make wireless communications. When the personal computer 2 and wireless device 3 must synchronously set an identical encryption key, the electronic apparatus of the third embodiment can provide a mechanism for automatically executing such processes.

FIG. 8 is a flow chart showing the operation sequence of the electronic apparatus of the third embodiment.

An operator in the manufacturer/distribution source of the wireless device 3 launches the utility software A on the personal computer 2 (step C1). After the utility software A is launched, since the unique information acquisition unit 21, encryption key generation unit 22, encryption key setting instruction unit 23, and encryption key setting unit 24 begin to run, the operator reads the production number, MAC address, or the like, which is printed as a barcode on an order form using the barcode reader 1. The production number, MAC address, or the like, which is read by the barcode reader 1, is acquired by the unique information acquisition unit 21 as information unique to the wireless device 3 (step C2).

The unique information acquisition unit 21 transfers the acquired information to the encryption key generation unit 22. On the other hand, the encryption key generation unit 22 generates an encryption key used by the wireless device 3 in wireless communications, on the basis of the transferred information (step C3). The encryption key setting unit 24 sets the encryption key generated by the encryption key generation unit 22 in the personal computer 2 (step C4).

Furthermore, the encryption key setting instruction unit 23 issues a command for setting the encryption key generated by the encryption key generation unit 22 to the wireless device 3 via the I/O controller 106 (step C5). In the wireless device 3 that receives this command via the I/O controller 207, the encryption key setting unit 31 stores this encryption key in the EEPROM 202 (step C6).

As described above, the electronic apparatus of this embodiment can easily synchronously set a unique encryption key for each set of the personal computer 2 and wireless device 3.

In the above embodiments, IEEE802.11b has been exemplified. However, the present invention is not limited to such specific standard, and may be applied to, e.g., IEEE802.11a.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An electronic apparatus comprising:
a first unit configured to acquire a device unique information of a wireless communication device;
a second unit configured to generate a data encryption key used when the wireless communication device makes a wireless communication based on the device unique information acquired by the first unit; and
a third unit configured to set the encryption key generated by the second unit in the wireless communication device.

2. The apparatus according to claim 1, wherein
the first unit acquires a production number of the wireless communication device.

3. The apparatus according to claim 1, wherein
the first unit acquires a MAC address assigned to the wireless communication device.

4. The apparatus according to claim 1, further comprising a barcode reader configured to read the barcode information, wherein
the first unit reads the device unique information via the barcode reader.

5. The apparatus according to claim 1, wherein
the second unit generates an ESS-ID.

6. The apparatus according to claim 1, wherein
the second unit generates a WEP key.

7. The apparatus according to claim 1, further comprising fourth unit configured to set the encryption key in a device on which the apparatus runs, the encryption key being set in the wireless communication device by the third unit.

8. A wireless communication device comprising:
a first unit configured to input a default setting instruction of a data encryption key used in a wireless communication;
a second unit configured to acquire a device unique information of a device upon receiving the default setting instruction by the first unit;
a third unit configured to generate an encryption key based on the device unique information acquired by the second unit; and
a fourth unit configured to set the encryption key generated by the third unit in the device.

9. An encryption key setting method comprising:
acquiring device unique information of a wireless communication device;
generating a data encryption key used when the wireless communication device makes a wireless communication, based on the device unique information; and
setting the encryption key in the wireless communication device.

10. An encryption key setting method comprising:
inputting a default setting instruction of a data encryption key used in a wireless communication;
acquiring device unique information of a device upon inputting the default setting instruction;
generating an encryption key based on the device unique information; and
setting the encryption key in the device.
